(19) United States
(12) Patent Application Publication
(10) Pub. No.: US 2013/0103562 A1
(43) Pub. Date: Apr. 25, 2013

(54) Method and System for Transferring Roth Securities

(71) Applicant: Thor Perplies, New York, NY (US)

(72) Inventor: Thor Perplies, New York, NY (US)

(21) Appl. No.: 13/507,605

(22) Filed: Jul. 13, 2012

Related U.S. Application Data
(60) Provisional application No. 61/574,599, filed on Aug. 5, 2011.

(51) Int. Cl. G06Q 40/06

(52) U.S. Cl. 705/37

(57) ABSTRACT

In accordance with the principles of the present invention, a computer implemented method of transferring ROTH 401(k) securities from one investor to another party is provided. The ROTH 401(k) securities are combined or aggregated. The system matches buyers and sellers of ROTH 401(k) securities. Prices for ROTH 401(k) securities are negotiated. ROTH 401(k) securities (securities) are transferred between the seller and the buyer. The buyer receives the securities. The seller receives money from the sale. The government receives tax dollars. Thus, taxes and securities for one investor are paid using money from another investor, and the taxing body realizes taxes within the same tax year.

### FIELD OF THE INVENTION

The application claims priority to U.S. Provisional Application Ser. No. 61/574,599 titled, “Method and System for Transferring Roth Securities” filed 5 Aug. 2012.

### FIELD OF THE INVENTION

The present invention relates to financial instruments, and to the electronic trading of such financial instruments.

### BACKGROUND OF THE INVENTION

The United State Government, and other institutions worldwide, grant companies tax credits that can be used to lower a company's taxes. Companies are given many tax incentives such as tax credits that are not available to individuals. Tax incentives such as tax credits allow companies to reduce their taxes, or profit by selling these tax credits to other companies. Tax credits are one example of a way taxes are traded between companies. Individuals are often left out of trading tax credits, because many tax credits are available to companies-only.

Today, tax credits may be sold through private exchanges. These private exchanges are often inefficient and require both companies in the exchange to have a broker. Several approaches have been proposed to improve the situation. For example, U.S. Patent Publication No. 2008/0147532 to Horsman et al. titled “System and Method for Transferring Tax Credits” describes a method for transferring tax credits from one party to another. A system layer receives at least one bid from a bidder for a plurality of tax credits. The system layer connects the bidder to an application layer via a communications path, and forwards the bid to the application layer. The application layer determines whether the bid from the bidder is highest for the plurality of tax credits. A display displays the highest bid for the plurality of tax credits.

U.S. Patent Publication No. 2002/0010674 to Kent titled “Method of Providing Tax Credits and Property Rental and Purchase” describes a method for auctioning off tax credits for real estate for a variety of parties by facilitating tax credit trading into specialized markets, and allows prospective renters and purchasers to search through available single family and multi-family dwellings, and do business with the seller/owner. U.S. Pat. No. 6,542,875 to Mulvihill et al. titled “Charitable and Public Funding using Tax Credits and Passive Losses” describes limited partnerships that are formed for specified public purposes, such as qualified low-income and elderly housing construction and services, and federally tax advantaged. Tax credits and/or passive losses are leveraged by being directed into a method of funding charitable works, for instance school construction projects. Nevertheless, it would be desirable to expand tax credits available to individuals.

### SUMMARY OF THE INVENTION

The present invention expands tax credits available to individuals. In accordance with the principles of the present invention, a computer implemented method of transferring ROTH 401(k) (ROTH 401K) securities from one investor to another is provided. The ROTH 401(k) securities are combined or aggregated. The system matches buyers and sellers of ROTH 401(k) securities. Prices for ROTH 401(k) securities are negotiated. ROTH 401(k) securities (securities) are transferred between the seller and the buyer. The buyer receives the securities. The seller receives money from the sale. The government receives tax dollars. Thus, the taxes and securities for one investor are paid using money from another investor, and the taxing body realizes taxes within the same tax year.

### BRIEF DESCRIPTION OF THE DRAWING

FIG. 1 is a chart of the associated parties.

FIG. 2 is a flow-chart setting forth an overview of the present invention.

FIG. 3 is a non-limiting example of a hardware infrastructure that can be used to run a system that implements the present invention.

### DETAILED DESCRIPTION OF A PREFERRED EMBODIMENT

The ROTH 401(k) is a type of retirement savings plan. The ROTH 401(k) was authorized by the United States Congress under the Internal Revenue Code, section 402A (Title 26 of the United States Code), and represents a unique combination of features of the ROTH Individual Retirement Account (IRA) and a traditional 401(k) plan. A ROTH IRA is a type of retirement plan that is generally not taxed, provided certain conditions are met. The law allows a tax reduction on a limited amount of saving for retirement. The ROTH IRA's principal difference from most other tax advantaged retirement plans is that, rather than granting a tax break for money placed into the plan, the tax break is granted on the money withdrawn from the plan during retirement.

A traditional 401(k) plan is a type of retirement savings account, which takes its name from subsection 401(k) of the Internal Revenue Code. In a traditional 401(k) plan, employees contribute pre-tax earnings to their retirement plan, also called “elective deferrals”. An employee's elective deferral funds are set aside by the employer in a special account where the funds are allowed to be invested in various options made available in the plan. Employers may also add funds to the account by contributing matching funds. Funds within the 401(k) account grow on a tax deferred basis. When the account owner reaches the age of 59-and-a-half, they may begin to receive “qualified distributions” from the funds in the account; these distributions are then taxed at ordinary income tax rates.

Under the ROTH 401(k), employees can decide to contribute funds on a post-tax elective deferral basis, in addition to, or instead of, pre-tax elective deferrals under their traditional 401(k) plans. An employee's combined elective deferrals—whether to a traditional 401(k), a ROTH 401(k), or to both—cannot exceed US$16,500 for tax year 2011 if a participant is under 50. In general, the difference between a ROTH 401(k) and a traditional 401(k) is that the ROTH version is funded with after-tax dollars while the traditional 401(k) is funded with pre-tax dollars and upon withdraw the ROTH securities are not taxed while the regular 401(k) securities are taxed.

Despite the tax advantages, some people who are in low tax brackets don't fully invest in their ROTH 401(k) or 401(k) accounts. People in low tax brackets often do not earn as much money as those in high tax brackets, and hence it is difficult for these people to max out their retirement savings plans. The low tax bracket individuals therefore often have the ability to invest more money in their retirement savings plans, but not the means to do so. In accordance with the principles of the present invention, these lower tax advantages can be passed along to investors that pay higher taxes for a fee. The present invention allows another investor, one that is likely in a higher tax bracket, to purchase these securities at the lower tax rate.

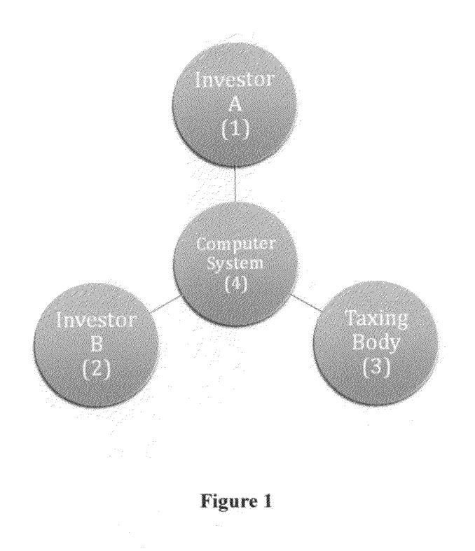

Referring first to FIG. 1, a description of the associated parties is set forth. Investor A is the “seller” of the ROTH 401(k) securities through the system of the present invention. This Investor A is taxed in a lower tax bracket. In addition, this Investor A does not max out their 401(k) and ROTH 401(k) account. This Investor A sells a portion of their ROTH 401(k) account.

Investor B is the “buyer” of the ROTH 401(k) securities. This Investor B buys securities by placing an order through the system of the present invention. This Investor B is taxed at a higher tax bracket, and therefore would benefit from purchasing securities which gives the Investor B a positive return because the securities are based on a lower tax bracket, like with Investor A.

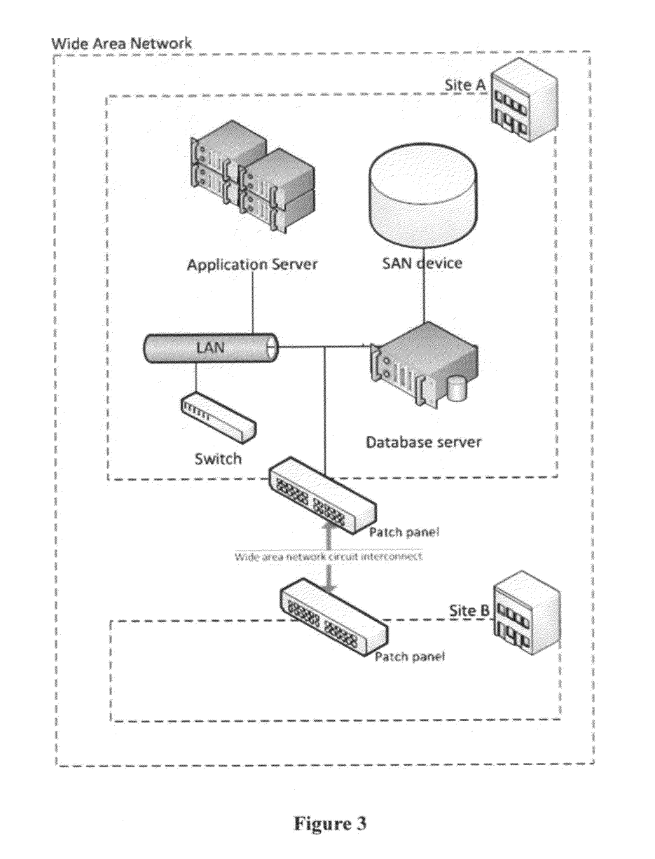

The buyers are matched with the sellers via a computer system. This system is secure, efficient, and available to individual investors through their ROTH 401(k) accounts. Referring now to FIG. 3, a non-limiting example of a hardware infrastructure that can be used to run a system that implements the present invention is seen. The infrastructure should include but not be limited to: wide area network connectivity, local area network connectivity, appropriate network switches and routers, electrical power (backup power), storage area network hardware, server-class computing hardware, and an operating system such as for example Redhat Linux Enterprise AS Operating System available from Red Hat, Inc, 1801 Varsity Drive, Raleigh, N.C.

The clearing and settling and administrative applications software server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Hewlett-Packard, Inc, located at 3000 Hanover Street, Palo Alto, Calif. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply, available from Hewlett-Packard

Referring back to FIG. 1, a taxing body receives the taxes from the ROTH 401(k) accounts in various jurisdictions. In the United States, this would be the Internal Revenue Service (IRS).

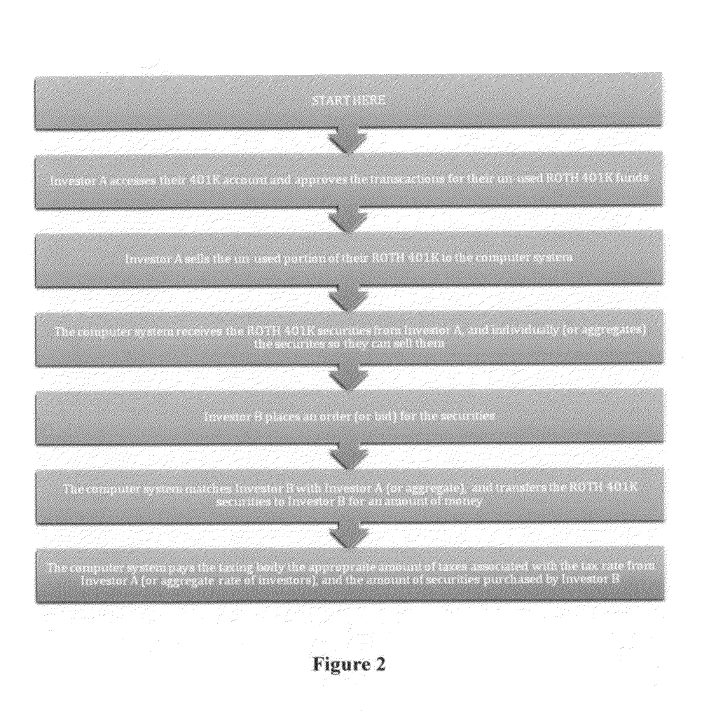

Referring now to FIG. 2, a flow-chart is provided setting forth an overview of the methodology of the present invention. Investor A provides securities from their ROTH 401(k) account via the computerized system. These securities are valued using the tax bracket from Investor A. In return for the securities, Investor A receives an amount of money that is deposited into their 401(k) accounts.

Investor B receives the ROTH 401(k) securities via the computerized system. Investor B buys the securities and the taxing body will receive the taxes based on Investor A's tax bracket. Investor B pays for this service by paying a fee to the company that provides the computerized system. These securities are taxed at Investor A's tax bracket. The fee that Investor B pays for this service funds Investor A's 401(k) deposit, and pays for the fees charged by the computer system company. The taxing body receives taxes from the exchange.

Thus, in the present invention Investor A receives an amount of money deposited into their 401(k) accounts that they normally would not have received at all. Investor B is able to buy investments with tax advantages. The taxing body receives taxes from the ROTH 401(k) securities immediately; normally, if the investor had 401(k) securities then the taxing body would have to wait for Investor A to retire and cash out their 401(k) accounts, which could take dozens of years. Further, if the investor did not max out their 401(k) then the government would not have collected any taxes. The taxing body benefits from new liquidity in the marketplace in the form of a new security offered and market.

The following is a non-limiting Example of the use of the present invention.

### Example

In 2011, Investor A is in a 25% tax bracket. Investor A contributes $6,500 per year to their ROTH 401(k) (and therefore has $10,000 left over to invest in their ROTH 401(k)). Investor B is in a 35% tax bracket. Investor B is looking to buy securities with better tax incentives.

Investor B pays the Clearinghouse C for service. The Clearinghouse C prepares and markets the appropriate ROTH 401(k) securities. Investor A has $10,000 left over in 2011 that they did not invest in their 401(k) that will be sold to Investor B. These funds are valued at $7,500 post-taxes according to Investor A's taxable bracket ($7,500=$10,000*75%; 75% of $10,000 is the amount of money left over after taxes for Investor A). Investor B values the same $10,000 differently because of their tax bracket. Normally this Investor B would have to pay in the 35% tax bracket for these securities, which would leave them with $6,500 from a similar $10,000 investment ($6,500=$10,000* 65%; 65% of $10,000 is the amount of money left over after taxes for Investor B). Investor B can be any party, including an individual or a company.

Clearinghouse C is able to sell the securities from Investor A to Investor B for $10,000 and pay $2,500 in taxes upfront. Investor B is left with $7,500 in post-tax securities. The Clearinghouse C charges Investor B a fee to perform this service. The Clearinghouse C pays Investor A a portion of this fee, and retains the remaining.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A computer implemented method of managing ROTH 401(k) securities comprising:
on a microprocessor in communication with a memory, aggregating at least two ROTH 401(k) securities;
the microprocessor matching buyers and sellers of ROTH 401(k) securities;
entering into the memory negotiated prices for ROTH 401(k) securities; and
the microprocessor transferring ROTH 401(k) securities between a seller and a buyer.

2. The computer implemented method of managing ROTH 401(k) securities of claim 1 further wherein the buyer receives the securities, and the seller receives money resulting from the sale.

3. The computer implemented method of managing ROTH 401(k) securities of claim 1 further wherein one party sells ROTH 401(k) securities to another party.

4. The computer implemented method of managing ROTH 401(k) securities of claim 1 further including matching buying ROTH 401(k) securities.

5. The computer implemented method of managing ROTH 401(k) securities of claim 1 further including matching selling ROTH 401(k) securities.

6. The computer implemented method of managing ROTH 401(k) securities of claim 1 further wherein, once a winning party is decided in the sale or auction of the securities, securities or tax credits or both are issued to another party.

7. The computer implemented method of managing ROTH 401(k) securities of claim 1 further including determining that there are ROTH 401(k) securities for sale.

8. The computer implemented method of managing ROTH 401(k) securities of claim 1 further wherein tax credits are transferred between two parties.

9. The computer implemented method of managing ROTH 401(k) securities of claim 1 further wherein one party pays taxes using money from another party.

10. The computer implemented method of managing ROTH 401(k) securities of claim 1 further wherein multiple ROTH 401(k) securities are blocked together and at least parts of the security are sold to another party.

11. The computer implemented method of managing ROTH 401(k) securities of claim 1 further wherein individuals can sell their unused 401(k) balances.

12. The computer implemented method of managing ROTH 401(k) securities of claim 1 further wherein taxed securities are transferred between two parties within different tax brackets.

13. The computer implemented method of managing ROTH 401(k) securities of claim 1 further wherein taxes for individuals are collected and paid based on the transferred retirement savings securities.

14. The computer implemented method of managing ROTH 401(k) securities of claim 1 further wherein a computer implemented marketplace is established for retirement savings securities.

15. A computer implemented method of managing ROTH 401(k) securities comprising:
on a microprocessor in communication with a memory, combining at least two ROTH 401(k) securities;
the microprocessor matching buyers and sellers of ROTH 401(k) securities;
entering into the memory negotiated prices for ROTH 401(k) securities; and
the microprocessor transferring ROTH 401(k) securities between a seller and a buyer.

16. The computer implemented method of managing ROTH 401(k) securities of claim 15 further wherein the buyer receives the securities, and the seller receives money from the sale.

17. The computer implemented method of managing ROTH 401(k) securities of claim 15 further wherein one party sells ROTH 401(k) securities to another party.

18. The computer implemented method of managing ROTH 401(k) securities of claim 15 further including matching buying ROTH 401(k) securities.

19. The computer implemented method of managing ROTH 401(k) securities of claim 15 further including matching selling ROTH 401(k) securities.

20. The computer implemented method of managing ROTH 401(k) securities of claim 15 further wherein, once a winning party is decided in the sale or auction of the securities, securities or tax credits or both are issued to another party.

21. The computer implemented method of managing ROTH 401(k) securities of claim 15 further including determining that there are ROTH 401(k) securities for sale.

22. The computer implemented method of managing ROTH 401(k) securities of claim 15 further wherein tax credits are transferred between two parties.

23. The computer implemented method of managing ROTH 401(k) securities of claim 15 further wherein one party pays taxes using money from another party.

29. The computer implemented method of managing ROTH 401(k) securities of claim 15 further wherein multiple ROTH 401(k) securities are blocked together and at least parts of the security are sold to another party.

24. The computer implemented method of managing ROTH 401(k) securities of claim 15 further wherein individuals can sell their unused 401(k) balances.

25. The computer implemented method of managing ROTH 401(k) securities of claim 15 further wherein taxed securities are transferred between two parties within different tax brackets.

26. The computer implemented method of managing ROTH 401(k) securities of claim 15 further wherein taxes for individuals are collected and paid based on the transferred retirement savings securities.

27. The computer-implemented method of managing ROTH 401(k) securities of claim 15 further wherein a computer implemented marketplace is established for retirement savings securities.
